(19) United States
(12) Patent Application Publication
(10) Pub. No.: US 2025/0218608 A1
(43) Pub. Date: Jul. 3, 2025

(54) LITHIUM HYDRIDE FIRST WALL

(71) Applicant: Renaissance Fusion, FONTAINE (FR)

(72) Inventor: Francesco VOLPE, FONTAINE (FR)

(21) Appl. No.: 18/850,486

(22) PCT Filed: Apr. 4, 2023
(86) PCT No.: PCT/EP2023/058832

§ 371 Date: Sep. 24, 2024

(30) Foreign Application Priority Data
Apr. 4, 2022 (EP) 22305451.1

(51) Int. Cl. G21B 1/13; G21B 1/05

(52) U.S. Cl. CPC G21B 1/13; G21B 1/057

(57) ABSTRACT

The present disclosure relates a first wall adapted to cover an inner wall (113) of a vessel (106), the first wall being made of a liquid metal mixture (111) comprising at least lithium and lithium hydride.

This application is based on and claims the priority benefit of European patent application number 22305451, filed on Apr. 4, 2022, entitled “LITHIUM HYDRIDE FIRST WALL”, which is hereby incorporated by reference to the maximum extent allowable by law.

### TECHNICAL FIELD

The present disclosure is related to first wall components in a vessel, such as a plasma confinement vessel, particularly it is related to confinement vessels where a liquid metal is used as a first wall. A first wall means a wall which directly faces the inside of the vessel, and first wall components mean components which directly face the inside if the vessel.

### BACKGROUND ART

The world currently depends heavily on fossil fuels, this dependency creates severe effects on climate, warming and biosphere degradation. The only alternative known to man is nuclear power, and the only one capable of achieving the appropriate safety and fuel efficiency is fusion power.

For fusion power to be an adequate alternative, fusion reactors need to be cheaper and smaller than the devices currently being envisioned, those based on the ITER design and DEMO. There is a need for fusion energy devices that are less complex, cheaper, and faster to construct.

The current devices being envisioned derive themselves from the designs of the 1990s, therefore these designs consider a minimum size with a major radius in the range of 6-9 m. Therefore, the production costs of actual reactors are enormous, prognosticated to over several billion dollars, and the construction time set to several decades with current construction methods. In addition to that, the cost of produced electricity by any power plant is affected by the cost of said power plant, which is approximately proportional to the plant's volume, so bigger machines, even if working on fusion principles would still produce electricity at a higher cost than other smaller machines. For these reasons there is a need for a fusion reactor that is smaller in size but that also has a higher fusion-power-density.

Further, fusion reactors also involve other sources of high costs during operation. One of them are the plasma facing components (PFCs), these are the components that face the plasma in the reaction chamber. PFCs are subject to very high energy during operation and as such the materials need to be replaced frequently. Another cost is that of the fuel, fusion power plants use tritium, a very expensive hydrogen isotope, for which the cost of a single gram may be as high as 30,000 dollars.

Those working in model fusion power plants have had little success in overcoming these difficulties in a way that also allow for reduction of the overall size of the reactor. As an example, ITER rests on 42-hectare platform and is over 70 meters tall. The follow-up reactor, DEMO, is expected to be even bigger with an increase in linear dimensions of about 15%.

The prior art teaches solutions as detailed next, some of them are based on using liquid metal as a plasma facing component. To the best understanding of the inventors these methods present a number of deficiencies that make them unsuitable or insufficient to accomplish the long-term goals of reducing the overall size of fusion reactor and increase the fusion-power density whilst also maintaining low costs.

A review of trends in liquid metals as plasma facing components is “On the exploration of innovative concepts for fusion chamber technology” by Abdou, et al. published in Fusion Engineering (2001) and Design 54 pp. 181-247. Specifically, Abdou notices that there are some possible advantages if concepts become realizable, including: high power density capacity, smaller and lower cost components and improvements in plasma stability and confinement. Abdou describes liquid metal mixtures in a liquid medium including Sn—Li mixtures, Pb—Li mixtures, and the molten salt FLiBe. Abdou also describes how to use these liquid metal mixtures and fashion them into a liquid wall, methods to push the liquid metal into the wall are described, including: gravity-momentum driven, which uses centrifugal force; electromagnetically restrained concept, in which current is injected to the flow so that a force field that pushes the flow to the wall is generated; and other methods that include pressure driving forces. Abdou notices in page 187 that it is not known whether the advantages are realizable into a single concept, and he then writes that even if just a subset of these advantages are achieved, a remarkable progress toward attractiveness of fusion energy systems would be accomplished. Therefore, there is a need for a solution that realistically implements said advantages into a single concept.

In U.S. Pat. No. 4,344,911 to Maniscalco, et. al. a fluidized wall for protecting fusion chamber walls is described. The fluidized wall is described in two ways, as being a liquid lithium metal waterfall or as being a waterfall of solid pellets of lithium-ceramic. The waterfall is described as forming a blanket that protects the structural materials of the chamber. Because the wall is described as using lithium it suffers from being a very poor neutron attenuator. Because the fluid is falling as a waterfall, additional complications from this configuration include open spaces in the waterfall and liquid density issues, which results in an uneven shielding. This is also true of the lithium-ceramic pebbles described.

Another material used for fusion reactor blankets is metal beryllium, having neutron multiplying properties. Pebbles created for this material have been described in, for example U.S. Pat. No. 5,958,105 to Ishitsuka et al. Such pebbles may not be allowed to come in contact with liquid metal mixtures as they may react making the pebbles unsuitable for their neutron multiplying purpose.

Thus, there remains a need for a solution to the fusion problem that addresses how to build a smaller, lower cost, and higher power density fusion reactors or their components, while still using readily available materials.

### SUMMARY OF INVENTION

One embodiment addresses all or some of the drawbacks of known plasma confinement walls or components.

One embodiment provides a first wall adapted to cover an inner wall of a vessel, the first wall being made of a liquid metal mixture comprising at least lithium and lithium hydride.

In one embodiment, the first wall further comprises pebbles suspended in the liquid metal mixture, each pebble being a neutron attenuating pebble, a neutron multiplying pebble or a neutron attenuating and multiplying pebble, the pebbles being for example sized between 1 and 5 mm.

In one embodiment, at least one of the pebbles have a core externally coated by an outer shell.

In one embodiment, the core is a hollowed core, for example filled with pores and/or the outer shell is a hollowed shell, for example filled with pores.

In one or several embodiments:
at least one of the pebbles is a neutron attenuating pebble and the core of said neutron attenuating pebble primarily comprises a material suitable for attenuating neutrons, preferably a material of high atomic number, for example lead; and/or
at least one of the pebbles is a neutron multiplying pebble and the core of said neutron multiplying pebble primarily comprises a material suitable for multiplying neutrons, for example beryllium; and/or
the outer shell primarily comprises a material suitable for stopping corrosion and/or interaction between lithium and the core, for example silicon carbide or graphite.

In one embodiment, at least some of the pebbles are located at an outer surface of the liquid metal mixture.

In one embodiment, the mixture comprises between 15 and 25% in molar content of lithium hydride, and the width of the first wall is for example comprised between 60 centimeters and 90 centimeters.

In another embodiment, the mixture comprises between 90% and 98% in molar content of lithium hydride, and the width of the first wall is for example comprised between 30 centimeters and 50 centimeters.

In one embodiment, the mixture further comprises lithium tritide and/or lithium deuteride.

In one embodiment, the mixture comprises between 15 and 25% in molar content of lithium hydride, lithium tritide and/or lithium deuteride, and the width of the first wall is for example comprised between 60 centimeters and 90 centimeters.

In another embodiment, the mixture comprises between 90% and 98% in molar content of lithium hydride, lithium tritide and/or lithium deuteride, and the width of the first wall is for example comprised between 30 centimeters and 50 centimeters.

One embodiment provides a vessel comprising an inner wall, wherein said inner wall is covered with a first wall according to an embodiment.

One embodiment provides a first wall device adapted to form a first wall according to an embodiment, wherein the device comprises:
a vessel comprising an inner wall;
flowing means adapted to form a flow of a liquid metal mixture on the inner wall.

One embodiment provides a first wall device adapted to form a first wall according to an embodiment, wherein the device comprises:
a vessel comprising an inner wall;
flowing means adapted to form a flow of a liquid metal mixture, comprising at least lithium and lithium hydride, on the inner wall, with pebbles suspended in the liquid metal mixture, each pebble being a neutron attenuating pebble, a neutron multiplying pebble, or a neutron attenuating and multiplying pebble.

In one embodiment, the flowing means comprise means for adding the pebbles in the liquid metal flow, for example hatchings or access points in a first tube of the flowing means.

In one embodiment, the flowing means are adapted to circulating the liquid metal mixture at high temperatures, for example at temperatures comprised between 600°° C. and 900° C.

In one embodiment, the flowing means comprises:
a pump;
a first tube between the pump and the vessel, the first tube being adapted to injecting the liquid metal mixture over the inner wall, the first tube being for example divided in at least two parts in the vessel; and
a second tube between the vessel and the pump, the second tube being adapted to collecting the liquid metal mixture flowing over the inner wall, the second tube being for example divided into at least two parts in the vessel.

In one or several embodiments, the flowing means:
are adapted to circulating the liquid metal mixture at high temperatures, for example at temperatures comprised between 600° C. and 900° C.; and/or
comprise means for adding pebbles to the liquid metal mixture, for example hatchings or access points in a first tube of the flowing means.

In one embodiment, the vessel or the device further comprises electrodes located on the inner wall of the vessel, the electrodes being adapted to applying an electric current to the liquid metal mixture of the first wall.

In one embodiment, the vessel or the device further comprises means for generating a magnetic field inside the vessel.

In one embodiment, the vessel has substantially a shape of a torus.

In one embodiment, the vessel forms at least part of a plasma confinement vessel, a nuclear reactor vessel, or an isotopic separation chamber.

One embodiment provides a method adapted to form a first wall according to an embodiment, wherein the method comprises injecting a liquid metal mixture to an inner wall of a vessel, the liquid metal mixture comprising at least lithium and lithium hydride.

In one embodiment, the method further comprises:
applicating an electric current to the liquid metal mixture during the injection step, for example through the use of electrodes located on the inner wall of the vessel;
applicating a magnetic field in the vessel during the injection step;
injecting pebbles in the liquid metal mixture before or during the injection step, each pebble being a neutron attenuating pebble, a neutron multiplying pebble or a neutron attenuating and multiplying pebble; and/or
collecting the liquid metal mixture from the vessel, after the injection step, and servicing the collected liquid metal mixture for another injection step in the vessel and/or to another device adapted to extract energy from said collected liquid metal mixture, such as a heat exchanger or a separator.

One embodiment provides a method adapted to form a first wall according to an embodiment, the method comprises injecting a liquid metal mixture to an inner wall of a vessel, the liquid metal mixture comprising at least lithium and lithium hydride, and forming a suspension of pebbles in the liquid metal mixture in the vessel, each pebble being a neutron attenuating pebble, a neutron multiplying pebble, or a neutron attenuating and multiplying pebble.

In one embodiment, the method further comprises:
applicating an electric current to the liquid metal mixture during the injection step, for example through the use of electrodes located on the inner wall of the vessel;
applicating a magnetic field in the vessel during the injection step;
injecting the pebbles in the liquid metal mixture before or during the injection step; and/or
collecting the liquid metal mixture from the vessel, after the injection step, and servicing the collected liquid metal mixture for another injection step in the vessel and/or to another device adapted to extract energy from said collected liquid metal mixture, such as a heat exchanger or a separator.

### Advantages

Advantages of an embodiment of the lithium hydride first wall device may be listed as: allow for much more compact first wall in a fusion reactor, the first wall may be as small as a few centimeters but usually between 10 to 20 cm or more; there is no need for a separate lithium breeding blanket because the first wall also acts as the breeding blanket, it is possible to modify the amount of attenuation or absorption of neutrons, so it is possible to test different configurations easily and to change on the fly the tritium breeding ratio. Therefore, it would be possible to construct smaller fusion reactors if the disclosed liquid first wall is used. Other advantages include the prolonged life-time of the solid parts of the reactor, including structural materials and normal-conducting or superconducting coils, improved safety and reduced maintenance and replacement costs in otherwise highly radioactive environments. Other technical advantages will become apparent to someone skilled in the art from the detailed description, figures, and claims. Moreover, while specific advantages have been enumerated above, different embodiments may include all, none or some of the advantages listed.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 is a general perspective view of an embodiment of the disclosed lithium hydride first wall.

FIG. 2 is a cross sectional view of a pebble.

### REFERENCE NUMERALS

102: pump
104a: outflow tube (first tube)
104b: inflow tube (second tube)
106: vessel
108: magnetic field
110: pebble
111: liquid metal flow (liquid metal mixture)
112: electrode(s)
113: inner wall(s)
114: outer surface
202: outer shell
204: core
206: pore(s)

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The following figures are not to scale. It should be noted that the drawings refer to an embodiment of the disclosed lithium hydride first wall, sometimes also referred simply as device, when no ambiguity in the text is anticipated. Other embodiments may be possible, and some are described in the figures as well. The actual dimension and/or shape of each of the components of the embodiment may vary. Only important details of the embodiment are shown, however one of ordinary skill in the art can appreciate how the overall device may be constructed, without undue experimentation.

Some details have been omitted from the drawings, but the inventors believe that adding these details is unnecessary for the overall appreciation of the characteristics of the invention disclosed. Some characteristics of the embodiment appear exaggerated to facilitate understanding. The embodiments disclosed, and alternatives observed should not be considered as limiting the invention in any way.

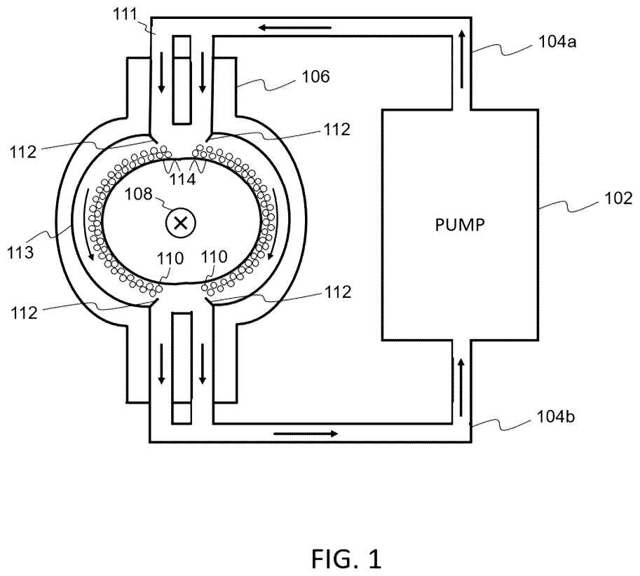

A first embodiment of lithium hydride first wall device is shown in FIG. 1. A pump 102 injects a liquid metal flow 111 (liquid metal mixture) by means of an outflow tube 104a (first tube) into a vessel 106. The outflow tube 104a may be split in two or more so that the liquid metal flow 111 may flow over the inner wall(s) 113 of the vessel 106. The liquid metal flow 111 may be filled with a plurality of pebbles 110. The liquid metal flow 111 returns to the pump by means of an inflow tube 104b. The inflow tube 104b (second tube) may have a plurality of inlets to collect the liquid metal flow 111 flowing over the inner walls 113 of the vessel 106.

A plurality of electrodes 112 may be disposed on the inner wall 113 of the vessel 106. A magnetic field 108 (B) may be applied inside of the vessel 106. The electrodes may apply a current of density j, resulting in a force of density jxB, which forces the liquid metal flow to stick to the solid wall.

According to an example, the vessel forms at least part of a plasma confinement vessel. In other examples, the vessel may form at least part of a nuclear reactor vessel, or of an isotopic separation chamber.

In the first embodiment, the pump 102 may be fashioned to allow for circulation of high temperature liquid metals. Operating temperatures may be between 600°° C. and 900° C. in fusion reactor applications. The inflow 104a and outflow 104b tubes are also adapted to operate at these temperatures. The inflow tube 104a takes the liquid metal flow 111 pumped from the pump 102 and services it to the inner wall(s) 113 of the vessel 106 from the top. The inner wall(s) 113 of the vessel 106 is (are) covered with the liquid metal flow 111. As the liquid metal 111 flows over the inner wall(s) 113, an outer surface 114 on the opposite side of the wall(s) 113 is formed by the liquid metal flow 111. In order to ensure that the inner wall(s) 113 of the vessel is (are) completely covered, it may be necessary to split the inflow tube 104a or accommodate for receptacles to divide the flow over the wall. The liquid metal flow 111 is collected at the bottom of the vessel 106 by receptacles that service the outflow tube 104b. The outflow tube 104b takes the liquid metal flow 111 back into the pump where it may then be recirculated.

In the first embodiment, the liquid metal flow 111 is primarily composed of a mixture of lithium and lithium hydride and may contain traces of other elements.

In said embodiment, the mixture of lithium and lithium hydride may be composed of at least 15% and at most 25% of lithium hydride, or at least 90% and at most 98%, this composition may be in the sense of molar content. Further, the mixture may contain lithium deuteride and/or lithium tritide. The content of the lithium hydride in the mixture allows for modification of the properties of the liquid metal flow 111. Changing the molar content of lithium hydride in the mixture modifies the attenuation and absorption properties of the liquid metal flow 111.

When the lithium hydride content in the mixture is between 15% and 25%, the width of the liquid metal flow 111 as measured from the inner wall(s) 113 of the vessel 106 may be between 60 cm and 90 cm to effect optimum attenuation or absorption as required by the fusion reactor application while also accomplishing tritium breeding at an acceptable rate.

When the lithium hydride content in the mixture is between 90% and 98%, the width of the liquid metal flow 111 as measured from the inner wall(s) 113 of the vessel 106 may be between 30 cm and 50 cm to effect optimum attenuation or absorption as required by the fusion reactor application while also accomplishing tritium breeding at an acceptable rate.

It should be apparent to anyone proficient in the art that adding lithium tritide and/or lithium deuteride to the mixture produces the same or similar results.

In the first embodiment, the vessel 106 may be shaped like a torus or in another similar shape. This shape would accommodate for fusion reactor applications. In such an embodiment, the inside of the vessel 106 is under the effect of a magnetic field 108. In FIG. 1, the magnetic field 108 is directed to the outside of the page. The magnetic field may be created by coils outside of the vessel 106 or some other appropriate method according to the application. The vessel 106 also contains a plurality of electrodes 112. Each of the electrodes 112 may be placed in a different location on the vessel 106 and they may be placed all over the inner wall(s) 113 of the vessel 106.

The first embodiment includes a plurality of pebbles 110. The pebbles 110 may be added to the liquid metal flow 111 prior to being loaded into the device, or the pebbles 110 may be added to the liquid metal flow 111 during operation, for example before injecting the liquid metal flow 111 into the vessel 106. In order to add pebbles 110 during operation, adequate hatchings or access points may be placed in the inflow tubes 104a.

Each pebble 110 may have a different function and two main varieties are identified in this first embodiment. A first variety have the function of attenuation of neutrons and are henceforth called neutron attenuating. A second variety are called neutron multiplying and have the function of multiplying the number of neutrons inside the liquid first wall. The two varieties and their functions can be combined in a single type of pebbles, containing both neutron attenuating materials and neutron multiplying materials, or materials that can simultaneously attenuate neutrons and multiply them, like lead.

As known by someone skilled in the art, neutron attenuation means the attenuation of the energy of a neutron by a collision with another particle, or a nucleus, with which energy is exchanged. For example, a high-energy neutron may be produced in a fusion reaction, and may hit solid, liquid and/or gaseous material surrounding the fusion plasma and collide with a nucleus, or several nuclei, of the atoms constituting said material. Typically, the high-energy neutron may release energy to the low-energy target, that is, the nucleus or nuclei in the surrounding material. Since the neutron lose energy in this process, it is said that its energy is attenuated. An attenuating material is a material which has a nucleus, or several nuclei, adapted to produce the attenuation of the energy of a neutron when collided with said neutron, for example a high-energy neutron, in order the neutron to lose energy.

Examples of neutron attenuating materials which can be used in a pebble comprise:
compounds of heavy elements, such as Lead (Pb), Tungsten (W), Tungsten Carbide (WC), Boronated Steel, or Vanadium Alloys, for example V-4Cr-4Ti;
high hydrogen content materials, such as metal hydrides, for example Titanium Hydride (TiH₂), Vanadium Hydride (VH₂), Zirconium Hydride (ZrH₂), or heavy water; and
other specialty materials including carbides, such as Boron Carbide (B₄C), Carbon, Titanium Carbide (TiC), Zirconium Carbide (ZrC), or a copper compound; or
a combination of any of the above-mentioned materials.

As also known by someone skilled in the art, multiplication of neutrons means a reaction indicated by (n, 2n), which means that a neutron may collide with a target nucleus and strip a neutron from said nucleus. One of the results of this reaction is the forming of two neutrons, the incident neutron, and the neutron extracted from the nucleus. Therefore, it is said that the neutron is multiplied. A multiplying material is a material which has a nucleus, or several nuclei, adapted to multiply a neutron when collided with said neutron.

Examples of neutron multiplying materials which can be used in a pebble comprise (excluding fissionable materials):
Beryllium (Be);
Lead, especially Pb206, Pb207, Pb208;
Lead Sulfide;
Tungsten (especially W182, W184, W186);
Molybdenum (especially Mo95, Mo97, Mo98, Mo100);
Zirconium (especially Zr92, Zr94, Zr96);
Bismuth (especially Bi209); or
a combination of any of these materials.

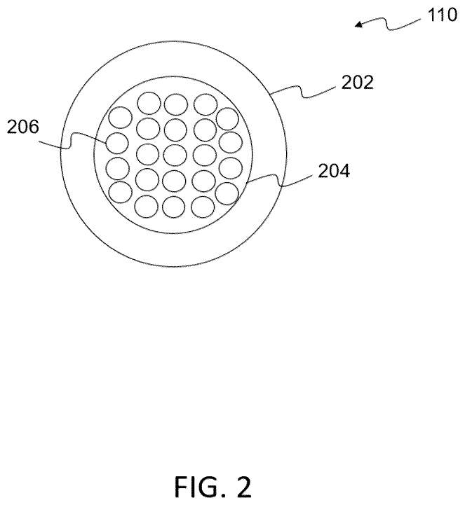

FIG. 2 shows a cross sectional view of a pebble 110. The cross-sectional view of FIG. 2 is common to both varieties described.

Each pebble 110 is constructed out of a core 204, and externally coated by an outer shell 202. Pebbles 110 may be constructed in a similar way to packed-bed beads that are common in nuclear fission applications. The outer shell 202 may be a coating of silicon carbide (SiC), graphite or other material suitable for stopping corrosion or interaction between lithium and the core 204. The core 204 may be of a different material according to the function of the pebble 110. The core 204 of a neutron attenuating pebble 110 may be constructed with lead or other materials of high atomic number, suitable for attenuating high energy neutrons, for example one or a plurality of the neutron attenuating materials mentioned above. The core 204 of a neutron multiplying pebble 110 may be constructed out of beryllium or other materials known for being adequate neutron multipliers, for example one or a plurality of the neutron multiplying materials mentioned above. In the first embodiment, pebbles 110 may be sized between 1 mm and 5 mm.

The core 204 may be filled by pores 206, thus making it hollow, which enables making the pebble 110 lighter. Alternatively, or additionally to the presence of pores, the outer shell 202 may be an electrical insulator or a poor conductor, so that the pebble is not or less subject to electromagnetic forces. Therefore, the pebble will not be or be less pushed radially outward. Instead, the pebble may float on the liquid metal-facing side of the vessel, where it is most needed and most effective for attenuation and multiplication of high-energy neutrons.

### Operation

To describe the operation of the disclosed liquid metal first wall, a fusion reactor application will be used. It should be apparent to someone skilled in the art that use in other applications might be profitable, for instance in the nuclear fission reactor field or even in the isotopic separation of elements field.

In the operation of the first embodiment as part of a fusion reactor, a pump 102 injects a liquid metal flow 111 to the inner wall(s) 113 of a vessel 106. As said, the vessel 106 is shaped like a torus and as such is hollow in the inside. There are pebbles 110 of the neutron attenuating and neutron multiplying variety suspended in the liquid metal 111. Said liquid metal is a mixture of lithium and lithium hydride, and may contain lithium deuteride and/or lithium tritide. Injection is made from the top of the vessel 106.

The liquid metal flow 111 may preferably be injected with a sufficiently high tangential velocity so that it may adhere to the inner wall(s) 113 by effect of a centrifugal force. Adherence to the inner wall(s) 113 is further maintained by the application of an electric current through the use of electrodes 112. An electric current is made circulate inside the liquid metal flow 111 in the poloidal direction. A magnetic field 108 is also applied in the toroidal direction. The interaction of the current and the magnetic field 108 causes an electromagnetic force that pushes the liquid metal flow 111 further into the inner wall 113.

As there are pebbles 110 suspended on the liquid metal flow 111, the action of the centrifugal and electromagnetic forces creates a situation of artificial gravity resulting in the pebbles 110 floating to the outer surface 114 of the liquid metal flow 111. This is due either to lower density (obtained by porosity) and/or to the outer shell 202 being an electrical insulator or a poor conductor, thus making the pebbles 110 at least partially immune to electromagnetic forces. The outer surface 114 of the liquid metal flow 111 is the one that faces the inside of the toroidal vessel 106. In the fusion reactor, a fusion reaction takes place in the inside of the vessel 106. Neutrons and other particles are ejected with high energy towards the outer surface 114 of the liquid metal flow 111. Neutrons interact with the pebbles 110, according to their function they result in attenuation of the neutrons and/or multiplication of the neutrons. Further, neutrons interact with the lithium and lithium hydride mixture in the liquid metal flow 111 resulting in further absorption and tritium breeding.

The liquid metal flow 111 is at a high temperature after this process. The liquid metal flow 111 is collected at the bottom of the vessel 106. The outflow tubes 104b then take the collected liquid metal flow and service other devices. For instance, other embodiments may include a heat exchanger, separators, or combinations of such, so that energy may be extracted from the liquid metal flow 111. Afterwards, the liquid metal flow is again serviced to the pump 102 and the process may continue.

The tritium breeding characteristics of the disclosed lithium hydride first wall depend on the composition and amount of pebbles 110 and the composition of the lithium hydride mixture in the liquid metal flow 111. Therefore, by modifying the pebbles 110 or the composition of the lithium hydride mixture, the size of the liquid metal flow 111 may be modified, and the size of a vessel 106 that uses the described lithium hydride first wall may be made smaller than what is currently being designed and constructed.

Additional Embodiments

In an additional embodiment, the lithium hydride content in the liquid metal flow 111 is as high as 90% or even further. In such an embodiment the width of the liquid metal flow 111 when measured from the inner wall 113 may be as low as few millimeters in order to achieve acceptable tritium breeding rates.

In another additional embodiment, the outflow tube 104b takes the liquid metal flow 111 and delivers it to another device. For instance, this other device could be a heat exchanger that would remove the heat from the liquid metal 111 and exchange it with a different fluid, this could be part of a power generation plant.

In yet another additional embodiment, the pores 206 inside the pebble 110 are not located in the core 204, but on the outer shell 202. In yet another embodiment pores 206 are located not only on the core 204 but also in the outer shell 202.

Example embodiments of the invention are summarized here. Other embodiments can also be understood from the entirety of the specification as well as the claims filed herein.

Example 1. A first wall adapted to cover an inner wall (113) of a vessel (106), the first wall being made of a liquid metal mixture (111) comprising at least lithium and lithium hydride.

Example 2. The first wall according to example 1, further comprising pebbles (110) suspended in the liquid metal mixture (111), each pebble being a neutron attenuating pebble, a neutron multiplying pebble or a neutron attenuating and multiplying pebble.

Example 3. The first wall according to example 2, wherein at least one of the pebbles (110) have a core (204) externally coated by an outer shell (202).

Example 4. The first wall according to example 3, wherein the core (204) is a hollowed core, for example filled with pores (206) and/or the outer shell (202) is a hollowed shell, for example filled with pores.

Example 5. The first wall according to example 3 or 4, wherein at least one of the pebbles (110) is a neutron attenuating pebble and the core (204) of said neutron attenuating pebble primarily comprises a material suitable for attenuating neutrons, preferably a material of high atomic number, for example lead; and/or at least one of the pebbles (110) is a neutron multiplying pebble and the core (204) of said neutron multiplying pebble primarily comprises a material suitable for multiplying neutrons, for example beryllium.

Example 6. The first wall according to any one of examples 3 to 5, wherein the outer shell (202) primarily comprises a material suitable for stopping corrosion and/or interaction between lithium and the core (204), for example silicon carbide or graphite.

Example 7. The first wall according to any one of examples 2 to 6, wherein the pebbles (110) are sized between 1 and 5 mm.

Example 8. The first wall according to any one of examples 2 to 7, wherein at least some of the pebbles (110) are located at an outer surface (114) of the liquid metal mixture (111).

Example 9. The first wall according to any one of examples 1 to 8, wherein the mixture further comprises lithium tritide and/or lithium deuteride.

Example 10. The first wall according to any one of examples 1 to 9, wherein the mixture comprises between 15 and 25% in molar content of lithium hydride, lithium tritide and/or lithium deuteride, and the width of the first wall is for example comprised between 60 centimeters and 90 centimeters; or the mixture comprises between 90% and 98% in molar content of lithium hydride, lithium tritide and/or lithium deuteride and the width of the first wall is for example comprised between 30 centimeters and 50 centimeters.

Example 11. A vessel (106) comprising an inner wall (113), wherein said inner wall is covered with a first wall according to any of examples 1 to 10.

Example 12. A first wall device adapted to form a first wall according to any one of examples 1 to 10, wherein the device comprises:
a vessel (106) comprising an inner wall (113);
flowing means (102, 104a, 104b) adapted to form a flow of a liquid metal mixture (111) on the inner wall (113).

Example 13. The device according to example 12, wherein the flowing means comprises:
a pump (102);
a first tube (104a) between the pump and the vessel (106), the first tube being adapted to injecting the liquid metal mixture (111) over the inner wall (113), the first tube being for example divided in at least two parts in the vessel.

Example 14. The device according to example 13, wherein the flowing means further comprises:
a second tube (104b) between the vessel (106) and the pump (102), the second tube being adapted to collecting the liquid metal mixture (111) flowing over the inner wall (113), the second tube being for example divided into at least two parts in the vessel.

Example 15. The device according to any one of example 12 to 14, wherein the flowing means are adapted to circulating the liquid metal mixture (111) at high temperatures, for example at temperatures comprised between 600°° C. and 900° C.

Example 16. The device according to any one of examples 12 to 15, wherein the flowing means comprise means for adding pebbles (110) to the liquid metal mixture (111), for example hatchings or access points in a first tube (104a) of the flowing means.

Example 17. The device according to any one of examples 12 to 16, or the vessel according to example 11, further comprising electrodes (112) located on the inner wall (113) of the vessel (106), the electrodes being adapted to applying an electric current to the liquid metal mixture (111) of the first wall.

Example 18. The device according to any one of examples 12 to 17, or the vessel according to example 11 or 17, further comprising means for generating a magnetic field (108) inside the vessel.

Example 19. The device according to any one of examples 12 to 18, or the vessel according to any one of examples 11, 17, 18, wherein the vessel (106) has substantially a shape of a torus.

Example 20. The device according to any one of examples 12 to 19, or the vessel according to any one of examples 11, 17 to 19, wherein the vessel (106) forms at least part of a plasma confinement vessel, a nuclear reactor vessel, or an isotopic separation chamber.

Example 21. A method adapted to form a first wall according to any of examples 1 to 10, wherein the method comprises injecting a liquid metal mixture (111) to an inner wall (113) of a vessel (106), the liquid metal mixture (111) comprising at least lithium and lithium hydride.

Example 22. The method according to example 21, wherein the liquid metal mixture (111) is injected with a sufficiently high tangential velocity so that it adheres to the inner wall (113) by effect of a centrifugal force.

Example 23. The method according to example 21 or 22, further comprising applicating an electric current to the liquid metal mixture (111) during the injection step, for example through the use of electrodes (112) located on the inner wall (113) of the vessel (106).

Example 24. The method according to any one of examples 21 to 23, further comprising applicating a magnetic field in the vessel (106) during the injection step.

Example 25. The method according to any one of examples 21 to 24, further comprising injecting pebbles (110) in the liquid metal mixture (111) before or during the injection step, each pebble being a neutron attenuating pebble, a neutron multiplying pebble or a neutron attenuating and multiplying pebble.

Example 26. The method according to any one of examples 21 to 25, further comprising collecting the liquid metal mixture (111) from the vessel (106), after the injection step and servicing the collected liquid metal mixture for another injection step in the vessel (106) and/or to another device adapted to extract energy from said collected liquid metal mixture, such as a heat exchanger, a separator.

Various embodiments and variants have been described. Those skilled in the art will understand that certain features of these embodiments can be combined and other variants will readily occur to those skilled in the art.

Finally, practical implementation of the the embodiments and variants described herein is within the capabilities of those skilled in the art based on the functional description provided hereinabove.

### LIST OF ACRONYMS

ITER: International Thermonuclear Experimental Reactor
DEMO: DEMOnstration Power Plant
PFCs: Plasma facing components
Sn: Tin
SiC: Silicon Carbide
Li: Lithium
Pb: Lead
FLiBe: Mixture of lithium fluoride and beryllium fluoride

1. A first wall adapted to cover an inner wall of a vessel, the first wall being made of a liquid metal mixture comprising at least lithium and lithium hydride, the first wall further comprising pebbles suspended in the liquid metal mixture, each pebble being a neutron attenuating pebble, a neutron multiplying pebble or a neutron attenuating and multiplying pebble.

2. The first wall according to claim 1, wherein the pebbles are sized between 1 and 5 mm.

3. The first wall according to claim 1, wherein at least one of the pebbles have a core externally coated by an outer shell.

4. The first wall according to claim 3, wherein the core is a hollowed core, for example filled with pores and/or the outer shell is a hollowed shell, for example filled with pores.

5. The first wall according to claim 3, wherein:
at least one of the pebbles is a neutron attenuating pebble and the core of said neutron attenuating pebble primarily comprises a material suitable for attenuating neutrons, preferably a material of high atomic number, for example lead; and/or
at least one of the pebbles is a neutron multiplying pebble and the core of said neutron multiplying pebble primarily comprises a material suitable for multiplying neutrons, for example beryllium; and/or
the outer shell primarily comprises a material suitable for stopping corrosion and/or interaction between lithium and the core, for example silicon carbide or graphite.

6. The first wall according to claim 1, wherein at least some of the pebbles are located at an outer surface of the liquid metal mixture.

7. The first wall according to claim 1, wherein:
the mixture comprises between 15 and 25% in molar content of lithium hydride, and the width of the first wall is for example comprised between 60 centimeters and 90 centimeters; or
the mixture comprises between 90% and 98% in molar content of lithium hydride, and the width of the first wall is for example comprised between 30 centimeters and 50 centimeters.

8. The first wall according to claim 1, wherein the mixture further comprises lithium tritide and/or lithium deuteride.

9. A vessel comprising an inner wall, wherein said inner wall is covered with a first wall according to claim 1.

10. A first wall device adapted to form a first wall according to claim 1, wherein the device comprises:
a vessel comprising an inner wall;
flowing means adapted to form a flow of a liquid metal mixture, comprising at least lithium and lithium hydride, on the inner wall, with pebbles suspended in the liquid metal mixture, each pebble being a neutron attenuating pebble, a neutron multiplying pebble, or a neutron attenuating and multiplying pebble.

11. The device according to claim 10, wherein the flowing means comprise means for adding the pebbles in the liquid metal flow, for example hatchings or access points in a first tube of the flowing means.

12. The device according to claim 10, wherein the flowing means comprises:
a pump;
a first tube between the pump and the vessel, the first tube being adapted to injecting the liquid metal mixture over the inner wall, the first tube being for example divided in at least two parts in the vessel; and
a second tube between the vessel and the pump, the second tube being adapted to collecting the liquid metal mixture flowing over the inner wall, the second tube being for example divided into at least two parts in the vessel.

13. The device according to claim 10, wherein the flowing means are adapted to circulating the liquid metal mixture at high temperatures, for example at temperatures comprised between 600°° C. and 900° C.

14. The device according to claim 10, or the vessel according to claim 9, further comprising electrodes located on the inner wall of the vessel, the electrodes being adapted to applying an electric current to the liquid metal mixture of the first wall.

15. The device according to claim 10, further comprising means for generating a magnetic field inside the vessel.

16. The device according to claim 10, wherein the vessel has substantially a shape of a torus.

17. The device according to claim 10, wherein the vessel forms at least part of a plasma confinement vessel, a nuclear reactor vessel, or an isotopic separation chamber.

18. A method adapted to form a first wall according to claim 1, wherein the method comprises injecting a liquid metal mixture to an inner wall of a vessel, the liquid metal mixture comprising at least lithium and lithium hydride, and forming a suspension of pebbles in the liquid metal mixture in the vessel, each pebble being a neutron attenuating pebble, a neutron multiplying pebble, or a neutron attenuating and multiplying pebble.

19. The method according to claim 18, wherein the method further comprises:
applicating an electric current to the liquid metal mixture during the injection step, for example through the use of electrodes located on the inner wall of the vessel;
applicating a magnetic field in the vessel during the injection step;
injecting the pebbles in the liquid metal mixture before or during the injection step; and/or
collecting the liquid metal mixture from the vessel, after the injection step, and servicing the collected liquid metal mixture for another injection step in the vessel and/or to another device adapted to extract energy from said collected liquid metal mixture, such as a heat exchanger or a separator.
